(19) United States
(12) Patent Application Publication
(10) Pub. No.: US 2005/0109445 A1
(43) Pub. Date: May 26, 2005

(54) Process for achieving a surface structure on a decorative laminate

(75) Inventors: Sven Kornfalt, Malmo (SE); Ake Sjoberg, Lund (SE)

Correspondence Address: STEVENS DAVIS MILLER & MOSHER, LLP, 1615 L STREET, NW, SUITE 850, WASHINGTON, DC, 20036, US

(73) Assignee: Pergo (Europe) AB, Trelleborg (SE)

(21) Appl. No.: 10/995,201

(22) Filed: Nov. 24, 2004

(30) Foreign Application Priority Data
Nov. 25, 2003 (SE) 0303146-5

(51) Int. Cl. B32B 31/00; B32B 31/04

(52) U.S. Cl. 156/64; 156/219; 156/555

(57) ABSTRACT

A process for the manufacture of a decorative laminate board, which laminate board includes at least one thermosetting resin impregnated paper layer. A decor paper in the form of a web or a sheet, provided with a plurality of decor sections, each decor section being intended to constitute a decor of a decorative panel, is placed as a surface layer on a base layer and bonded thereto by pressing under elevated pressure. The laminate board achieved is then rolled between a plurality of rollers. The plurality of rollers comprises at least one counter-stay roller on a under side of the laminate board and a plurality of structure rollers on the decor side of the laminate board. Each of the structure rollers have a width which is less than ⅓ of the width of the laminate board, wherein each structure roller is used for embossing a predetermined portion of the laminate board.

The present invention relates to a process for the manufacture of a decorative thermosetting laminate with a surface structure that realistically matches the decor of the upper surface.

Products coated with thermosetting laminates are frequent today. They are foremost used where the demand for abrasion resistance is high, but also where resistance towards different chemicals and moisture is required. As an example of such products floors, floor beadings, table tops, work tops and wall panels can be mentioned.

The thermosetting laminate often consists of at least a base with a decor sheet placed closest to the surface. The decor sheet can be provided with a desired decor or pattern. The most frequent patterns usually represent the image of different kinds of wood, or minerals such as marble or granite. The surface of the laminate can be provided with a structure during the laminating procedure which will make the decor more realistic. Press plates with structure or structure foils are frequently used when manufacturing such a laminate. A negative reproduction of the structure in the press plate or the foil will be imprinted into the laminate during the laminating procedure.

The structure suitably represents features characteristic for the pattern the decor represents in the laminate. The structure can be made coarse to simulate for example roughly planed stone, or smooth with randomly placed pits and micro cracks to simulate polished marble. A wood surface is simulated by providing the surface with randomly placed thin oblong indentations which imitate pores. There are however some difficulties to achieve a match between the decor and the structure. This is mainly due to the fact the substrate holding the decor is subject to a number of treatments which will inevitably change its format. The substrate carrying the surface structure will not be subject to the same format change as the decor substrate. It will hereby be virtually impossible to achieve a desired alignment between printed decor and surface structure over the whole surface of the board produced.

It has for a long time been a great need to be able to manufacture a decorative thermosetting laminate with a decor pattern for example with decor sections directed in different directions and with a matching surface structure.

According to the present invention the above mentioned needs have been met and a thermosetting laminate with a decorative surface with a matching surface structure has been achieved. Accordingly the invention relates a process for the manufacturing of a decorative laminate board. The laminate board includes at least one thermosetting resin impregnated paper layer, wherein a decor paper in the form of a web or a sheet, provided with a plurality of decor sections, each decor section being intended to constitute a decor of a decorative panel, is placed as a surface layer on a base layer and bonded thereto by pressing under elevated pressure. A laminate board is hereby achieved. The laminate board is then rolled between a plurality of rollers. The plurality of rollers comprises at least one counter-stay roller on a under side of the laminate board and a plurality of structure rollers on the decor side of the laminate board. Each of the structure rollers have a width which is less than ⅓ of the width of the laminate board. Each structure roller is used for embossing a predetermined portion of the laminate board. The structure rollers are advantageously adjustable in a direction perpendicular to the feeding direction of the laminate board. This adjustment is made in order to compensate for differences in the size of the decor paper. Such a decor paper is subject to a number of processes during its making, which will change its format in a way which is difficult to fully anticipate. It is desirable to use an automatic process for adjusting for these format differences in the decor. Accordingly, the structure rollers are suitably adjusted in the perpendicular direction guided through means of a computer utilising data retrieved from the decor paper of the laminate board, whereby it will become possible to achieve embossing in the laminate board, achieved by means of the structure rollers, which is in register with the decor of the decor paper. One or more ccd camera may be used for retrieving the data used for guiding the structure rollers.

The structured rollers is advantageously used for providing the decorative surface of the laminate board with recessed portions. The recessed portions simulates parting lines between visually depicted decor sections. It is understood from the present invention that these recessed portions can constitute longitudinal lines in the laminate board. If such lines is desired also in a direction perpendicular to said longitudinal direction, the laminate board may be embossed twice, the first time as described above and the second time being a repetition after having turned the board 90°. The process described in the present invention is advantageously used when providing a laminate board with a surface structure simulating features like borders between depicted wood blocks, wood strips or marble slabs in a block design. In this case the structure roller may be very narrow having an almost knife like edge.

The process may also be used for achieving bevelled edges on a panel. It may further be utilised for achieving a simulated grout line between ceramic tiles or a rubber insert between wood panels. In this case the structured rollers are wider and may even be provided with a surface structure so that, for example, the texture of the grout line, or even a wood texture may be simulated.

The structured rollers may further be provided with pigmentation on the embossing portion, which pigmentation is intended to be transferred to the embossed portions of the laminate board. The pigmentation is used for enhancing the effect of the embossing.

It is highly advantageous to make the embossing while the laminate is warm. This may be achieved by making the embossing directly after the lamination procedure. The surface temperature of the laminate board is preferably above 50° C. during the embossing procedure. It also advantageous to heat the structure rollers so that the surface temperature of the structure roller is higher than 50° C. during the embossing procedure.

1. A process for the manufacture of a decorative laminate board, which laminate board includes at least one thermosetting resin impregnated paper layer, wherein a decor paper in the form of a web or a sheet, provided with a plurality of decor sections, each decor section being intended to constitute a decor of a decorative panel, is placed as a surface layer on a base layer and bonded thereto by pressing under elevated pressure so that a laminate board is achieved, wherein the laminate board is rolled between a plurality of rollers, the plurality of rollers comprising at least one counter-stay roller on a under side of the laminate board and a plurality of structure rollers on the decor side of the laminate board, that each of the structure rollers have a width which is less than ⅓ of the width of the laminate board, wherein each structure roller is used for embossing a predetermined portion of the laminate board.

2. A process according to claim 1 wherein the structure rollers are adjustable in a direction perpendicular to the feeding direction of the laminate board.

3. A process according to claim 2 wherein the surface temperature of the laminate board is above 50° C. during the embossing procedure.

4. A process according to claim 2 wherein the surface temperature of the structure roller is higher than 50° C. during the embossing procedure.

5. A process according to claim 2 wherein the structure rollers are adjusted in the perpendicular direction guided through means of a computer utilising data retrieved from the decor paper of the laminate board, whereby it will become possible to achieve embossing in the laminate board, achieved by means of the structure rollers, which is in register with the decor of the decor paper.

6. A process according to claim 5 wherein a ccd camera is used for retrieving the data used for guiding the structure rollers.

7. A process according to claim 1 wherein the structured rollers is used for providing the decorative surface of the laminate board with recessed portions, the recessed portions simulating parting lines between visually depicted decor sections.
